(19) United States
(12) Patent Application Publication
(10) Pub. No.: US 2026/0192601 A1
(43) Pub. Date: Jul. 9, 2026

(54) PNEUMATIC TIRE

(71) Applicant: TOYO TIRE CORPORATION, Itami-shi (JP)

(72) Inventor: Akito NAKATANI, Itami-shi (JP)

(73) Assignee: TOYO TIRE CORPORATION, Itami-shi (JP)

(21) Appl. No.: 19/437,990

(22) Filed: Dec. 31, 2025

(30) Foreign Application Priority Data
Jan. 9, 2025 (JP) 2025-003198

(51) Int. Cl. B60C 11/03

(52) U.S. Cl. CPC B60C 11/0302; B60C 2011/0346

(57) ABSTRACT

Provided is a pneumatic tire capable of reducing the likelihood that a tip portion of a V-shaped land decreases in rigidity and experiences uneven wear, thereby improving steering stability. A pneumatic tire includes a tread and has a tire rotation direction specified therefore. The tread includes a first V-shaped land as a V-shaped land projecting toward a forward side of the tire rotation direction, and a V-shaped groove as a groove externally defining the first V-shaped land, and the first V-shaped land includes a tapered portion extending toward the forward side of the tire rotation direction from a leading edge of the first V-shaped land closer to the forward side of the tire rotation direction, the tapered portion being inclined from the leading edge toward a bottom of the V-shaped groove.

### BACKGROUND OF THE INVENTION

This application is based on and claims the benefit of priority from Japanese Patent Application No. 2025-003198, filed on 9 Jan. 2025, the content of which is incorporated herein by reference.

### FIELD

The present invention relates to a pneumatic tire.

### BACKGROUND

In general, a pneumatic tire has, on the surface of its tread that contacts with a road surface, a tread pattern in which grooves and lands having various shapes are formed in order to ensure drainage performance, traction performance, and the like.

For example, Japanese Unexamined Patent Application, Publication No. H8-310205 discloses a pneumatic tire having a specified rotation direction and provided with a tread pattern in which V-shaped lands are formed in a central portion in the tire axial direction of the tread. The V-shaped lands each have a tapered tip portion oriented toward a forward side of the rotation direction, that is, the side that contacts with the ground prior to the other side.

### SUMMARY

The V-shaped lands projecting toward the forward side of the rotation direction as disclosed in Japanese Unexamined Patent Application, Publication No. H8-310205 may have low rigidity in their tapered tip portions.

In the case where the tapered tip portions have low rigidity, the likelihood of kinking and uneven wear increases, which may result in deterioration of steering stability. As such, there is room for improvement.

An object of the present invention is to provide a pneumatic tire capable of reducing the likelihood that a tip portion of a V-shaped land decreases in rigidity and experiences uneven wear, thereby improving steering stability.

A pneumatic tire according to an embodiment of the present invention includes a tread and has a tire rotation direction specified therefor. The tread includes: a V-shaped land projecting toward a forward side of the tire rotation direction; and a groove externally defining the V-shaped land. The V-shaped land includes a tapered portion extending toward the forward side of the tire rotation direction from a leading edge of the V-shaped land closer to the forward side of the tire rotation direction, and the tapered portion is inclined from the leading edge toward a bottom of the groove.

The present invention provides a pneumatic tire capable of reducing the likelihood that a tip portion of a V-shaped land decreases in rigidity and experiences uneven wear, thereby improving steering stability.

### BRIEF DESCRIPTION OF THE DRAWINGS

FIG. 1 is a diagram illustrating a tread pattern of a pneumatic tire according to an embodiment, and is a partial plan view of the pneumatic tire;

FIG. 2 is an enlarged view of the portion denoted by the reference sign of II in FIG. 1;

FIG. 3 is a cross-sectional view taken along line III-III in FIG. 2; and

FIG. 4 is an enlarged view of the portion denoted by the reference sign of IV in FIG. 1.

### DETAILED DESCRIPTION OF THE EMBODIMENTS

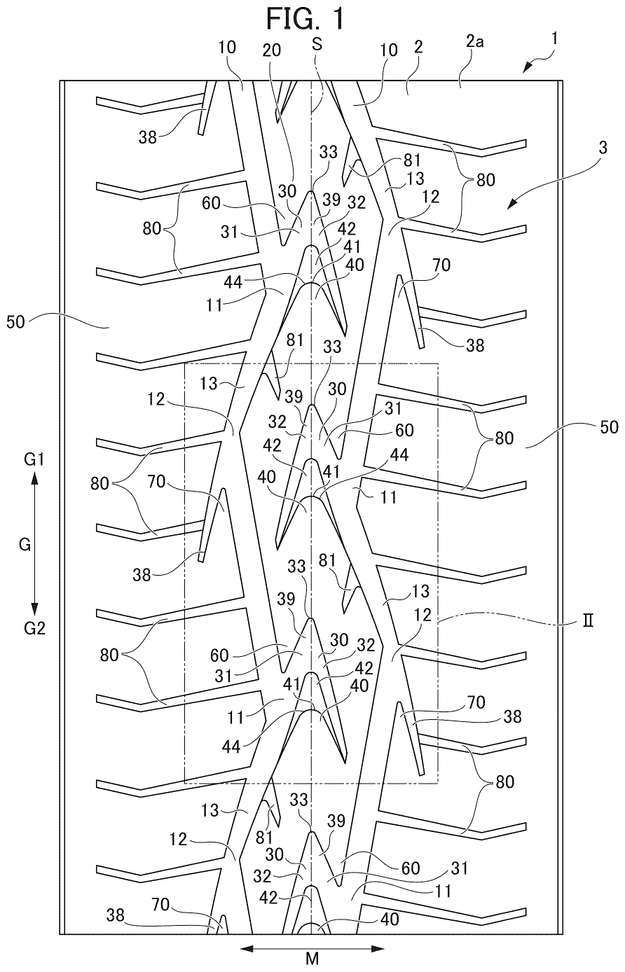

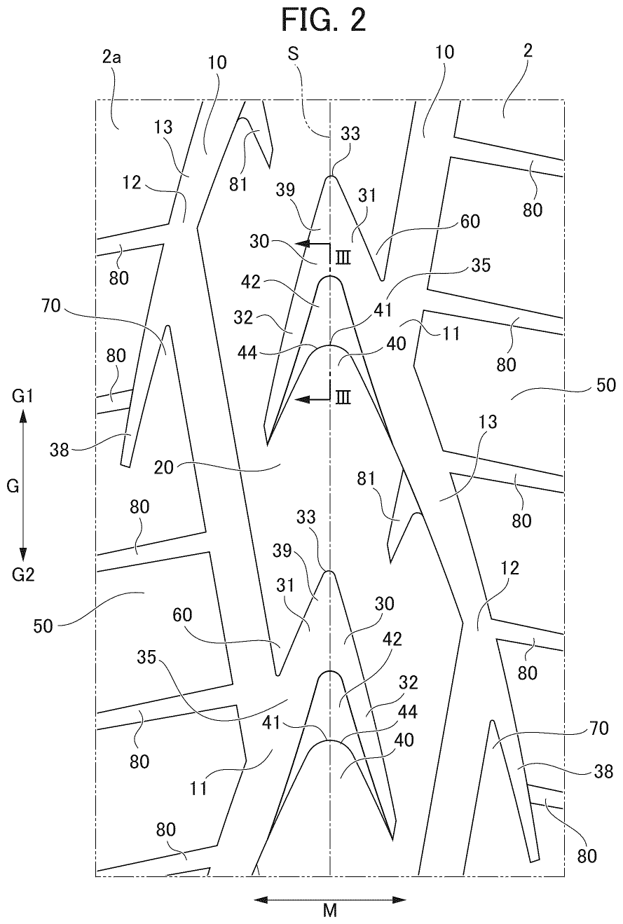

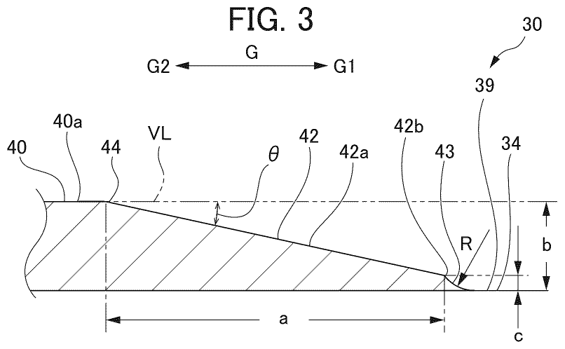

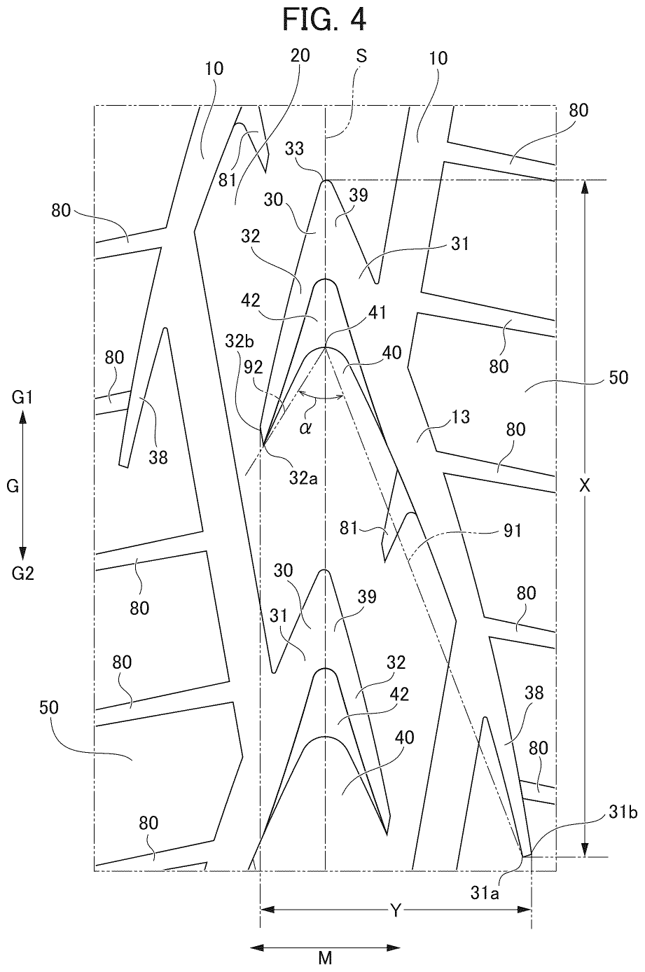

The following describes embodiments with reference to the drawings. FIG. 1 is a plan view of a surface 2a of a tread 2 of a tire 1 that is a pneumatic tire for a vehicle according to an embodiment. FIG. 2 is an enlarged view of the portion denoted by the reference sign of II in FIG. 1. FIG. 3 is a diagram illustrating a cross section in a tire radial direction, taken along the line III-III in FIG. 2. FIG. 4 is a diagram corresponding to FIG. 2.

The tire 1 according to the embodiment is, for example, a pneumatic tire for a passenger vehicle. The configuration of the tire 1 of the embodiment is also applicable to tires for various vehicles such as a light truck, a truck, and a bus.

In FIGS. 1, 2, and 4, a tire axial direction is indicated by the double arrow M, and a tire circumferential direction is indicated by the double arrow G. In FIG. 3, the tire circumferential direction is indicated by the double arrow G. For the tire 1 of the embodiment, a direction toward one side of the tire circumferential direction is specified as the forward side of a tire rotation direction. In FIGS. 1 to 4, the arrow head G1 indicates the forward side of the tire rotation direction corresponding to the tire circumferential direction, and the arrow head G2 indicates an opposite side to the forward side G1 of the tire rotation direction. For the tire 1, a portion closer to the forward side of the tire rotation direction may be referred to as the leading side of the tire, and a portion closer to the opposite side to the forward side of the tire rotation direction may be referred to as the trailing side of the tire.

FIGS. 1, 2, and 4 further show a tire equator S extending along the tire circumferential direction G and passing through the center in the tire axial direction M of the tread 2.

As illustrated in FIG. 1, the tread 2 includes a tread pattern 3 on the surface 2a. The tread pattern 3 includes a pair of main grooves 10, a center land 20 between the pair of main grooves 10, a plurality of V-shaped grooves 30 arranged in the center land 20 between the pair of main grooves 10 and each including a V-shaped portion 39, a plurality of first V-shaped lands 40 defined by the V-shaped portions 39 and forming part of the center land 20, and a pair of side lands 50 disposed on outer sides in the tire axial direction of the main grooves 10. The V-shaped groove 30 of the embodiment is one example of the grooves of the present disclosure. Each first V-shaped land 40 is one example of the V-shaped lands of the present disclosure. It should be noted that in the present specification, any shape that per se appears to be a V-shape when viewed in an arbitrary direction is referred to as a V-shape or a V-shaped land, a V-shaped groove, or the like, regardless of the up-down direction and the left-right direction of the drawings.

The main grooves 10 extend in a zigzag shape along the tire circumferential direction. Each main groove 10 has inward bent portions 11 at which the main groove 10 bends to extend inward toward the tire equator S in the tire axial direction, and outward bent portions 12 at which the main groove 10 bends to extend outward away from the tire equator S in the tire axial direction. The pair of main grooves 10 are formed in a pattern in which the inward bent portions 11 of one main groove 10 alternate with the inward bent portions 11 of the other main groove 10 in the tire circumferential direction, and the outward bent portions 12 of one main groove 10 alternate with the outward bent portions 12 of the other main groove 10 in the tire circumferential direction. For the pair of main grooves 10, the inward bent portions 11 of one main groove 10 are arranged inward in the tire axial direction relative to, and in correspondence with, the outward bent portions 12 of the other main groove 10, and the inward bent portions 11 of the other main groove 10 are arranged inward in the tire axial direction relative to, and in correspondence with, the outward bent portions 12 of the one main groove 10. Due to this pattern in which the pair of main grooves 10 extend in a zigzag shape, the center land 20 also has a substantially zigzag shape extending along the tire circumferential direction.

As illustrated in FIG. 2, the V-shaped portions 39 constituting the plurality of V-shaped grooves 30 are formed corresponding to the inward bent portions 11 of the main grooves 10 on a one-to-one basis. Each V-shaped portion 39 has a V-shape whose groove tip portion including a groove apex 33 projects toward the forward side of the tire rotation direction.

As illustrated in FIGS. 1 and 2, a plurality of projecting groove segments 38 each forming part of a first groove 31 (to be described later) are formed in the side lands 50 disposed outward in the tire axial direction of the main grooves 10. The projecting groove segments 38 have a spine shape, project from the outward bent portions 12 of the main grooves 10 in a direction opposite to the forward side of the tire rotation direction, are inclined outward in the tire axial direction, and terminate in the side lands 50.

The ends of the projecting groove segments 38 closer to the forward side of the tire rotation direction communicate with the outward bent portions 12 of the main grooves 10. The projecting groove segments 38 communicating with the one main groove 10 alternate with the projecting groove segments 38 communicating with the other main groove 10 along the tire circumferential direction.

Each V-shaped groove 30 includes a first groove 31 and a second groove 32. With respect to the groove apex 33 projecting toward the forward side of the tire rotation direction, the first groove 31 is disposed on a side closer to the main groove 10 with which the V-shaped groove 30 communicates, and the second groove 32 is disposed on a side opposite to the main groove 10. The first groove 31 and the second groove 32 extend in directions inclined opposite to each other with respect to the tire circumferential direction.

The first groove 31 of each V-shaped groove 30 communicates with the inward bent portion 11, and continues from the inward bent portion 11 to the projecting groove segment 38 through a part of the main groove 10. In the present embodiment, the first groove 31 includes a groove segment extending from the groove apex 33 of the V-shaped portion 39 to the projecting groove segment 38 through the inward bent portion 11. In other words, the first groove 31 of the present embodiment shares, with the main groove 10, a straight segment 13 extending between the inward bent portion 11 and the projecting groove segment 38 in the main groove 10.

The second groove 32 of each V-shaped groove 30 has an end closer to an opposite side to the forward side of the tire rotation direction, and the end extends toward the other main groove 10 adjacent to the main groove 10 with which the V-shaped groove 30 communicates, and terminates in the center land 20 without reaching the other main groove 10.

As illustrated in FIG. 2, the groove apexes 33 of the V-shaped grooves 30 projecting toward the forward side of the tire rotation direction are disposed on the tire equator S. The V-shaped grooves 30 communicating with one main groove 10 and the V-shaped grooves 30 communicating with the other main groove 10 are alternately arranged at substantially equal pitches in the tire circumferential direction. The V-shaped portions 39 of the V-shaped grooves 30 are arranged between the pair of main grooves 10.

As illustrated in FIG. 2, each of the plurality of first V-shaped lands 40 is formed closer to the opposite side to the forward side of the tire rotation direction with respect to the V-shaped portion 39 of the corresponding V-shaped groove 30. In other words, each first V-shaped land 40 is externally defined by the V-shaped portion 39 of the corresponding V-shaped groove 30. Each first V-shaped land 40 has a V-shape whose tip portion including a land apex 41 projects toward the forward side of the tire rotation direction. The land apexes 41 of the first V-shaped lands 40 are disposed on the tire equator S. Each first V-shaped land 40 preferably has an arc-shaped leading edge in plan view.

As illustrated in FIGS. 1 and 2, the center land 20 includes a plurality of second V-shaped lands 60, and the side lands 50 include a plurality of third V-shaped lands 70. The second V-shaped lands 60 are integral with the center land 20 and form part of the center land 20. The third V-shaped lands 70 are integral with the side lands 50 and form part of the side lands 50.

Each V-shaped groove 30 meets the corresponding main groove 10 in a communication segment 35 through which the grooves 30 and 10 communicate with each other. Each of the second V-shaped lands 60 is disposed closer to the forward side of the tire rotation direction with respect to the corresponding communication segment 35. Each of the second V-shaped lands 60 has a V-shape projecting toward the opposite side to the forward side of the tire rotation direction. Each of the second V-shaped lands 60 has a V-shape defined between the first groove 31 of the corresponding V-shaped portion 39 and the corresponding main groove 10. The second V-shaped lands 60 communicating with one main groove 10 and the second V-shaped lands 60 communicating with the other main groove 10 are respectively arranged on opposite sides in the tire axial direction of the tire equator S, and alternate with each other along the tire circumferential direction. Each second V-shaped land 60 projecting toward the opposite side to the forward side of the tire rotation direction preferably has an arc-shaped leading edge in plan view. Further, it is preferable that edges of each second V-shaped land 60 continuous with the main groove 10 and the first groove 31 have a round shape that is concave toward the groove bottom.

Each of the third V-shaped lands 70 has a V-shape projecting toward the forward side of the tire rotation direction. Each of the third V-shaped lands 70 has a V-shape defined between the corresponding projecting groove segment 38 and the corresponding main groove 10. The third V-shaped lands 70 communicating with one main groove 10 and the third V-shaped lands 70 communicating with the other main groove 10 alternate with each other along the tire circumferential direction. Each third V-shaped land 70 projecting toward the forward side of the tire rotation direction preferably has an arc-shaped leading edge in plan view. Further, it is preferable that edges of each third V-shaped land 70 continuous with the main groove 10 and the projecting groove segment 38 have a round shape that is concave toward the groove bottom.

As illustrated in FIG. 1, a plurality of lug grooves 80 are formed in the pair of side lands 50. The plurality of lug grooves 80 communicate with the main groove 10 adjacent to the respective side land 50, and some of them communicate with the projecting groove segments 38. The plurality of lug grooves 80 extend substantially along the tire axial direction and are arranged at substantially equal pitches in the tire circumferential direction. Each of the lug grooves 80 extends outward in the tire axial direction from the corresponding main groove 10 or the corresponding projecting groove segment 38 while being slightly inclined toward the opposite side to the forward side of the tire rotation direction, has a leading end portion bent toward the opposite side to the forward side of the tire rotation direction, and terminates in the corresponding side land 50.

As illustrated in FIG. 1, a plurality of notches 81 communicating with the main grooves 10 are formed in the center land 20. Each of the notches 81 is disposed between the outward bent portion 12 of the main groove 10 and the V-shaped portion 39. Each notch 81 is a relatively short notch-shaped groove that extends toward the opposite side to the forward side of the tire rotation direction and is inclined toward the tire equator S.

As illustrated in FIG. 3, each first V-shaped land 40 has a tapered portion 42 closer to the forward side of the tire rotation direction. The tapered portion 42 is inclined toward the forward side of the tire rotation direction from a leading edge 44 of the first V-shaped land 40 closer to the forward side of the tire rotation direction so that the tapered portion 42 gradually decreases in height from the leading edge 44 toward a bottom 34 of the V-shaped portion 39 of the V-shaped groove 30. As illustrated in FIG. 2, each tapered portion 42 has a leading edge closer to the forward side of the tire rotation direction, and the leading edge has a V-shape projecting toward the forward side of the tire rotation direction.

As illustrated in FIG. 3, in a tire radial cross section, it is preferable that an angle θ formed between a virtual extension line VL extending toward the forward side of the tire rotation direction from a surface 40a of the first V-shaped land 40 and a surface 42a of the tapered portion 42 is 20° or more and 45° or less.

As illustrated in FIG. 3, in the tire radial cross section, a curved concavity 43 having a concave cross section and continuing to the bottom 34 of the V-shaped groove 30 is formed from a leading end 42b of the tapered portion 42 closer to the forward side of the tire rotation direction toward the forward side of the tire rotation direction. The curved concavity 43 has an arc-shaped cross section in the tire radial cross section. The radius R of the curved concavity 43 is preferably 1.0 mm or more and 5.0 mm or less.

As illustrated in FIG. 3, when the height of the curved concavity 43 from the bottom 34 of the V-shaped groove 30 is defined as c, the height of the first V-shaped land 40 from the bottom 34 of the V-shaped groove 30 is defined as b, and the length of the tapered portion 42 in the tire circumferential direction is defined as a in the tire radial cross section, the angle θ is expressed by the following equation:

$$θ = {tan}^{- 1} ( b - c ) / a$$

In the present embodiment, the ratio c/b, i.e., the ratio of the height c of the curved concavity 43 to the height b of the V-shaped groove 30, is preferably 5% or more and 50% or less, and more preferably 10% or more and 25% or less.

The radius R of the curved concavity 43 is preferably larger than the height c of the curved concavity 43. Due to this configuration, the curved concavity 43 is easily made gentle, the rigidity of the tapered portion 42 and thus the rigidity of the first V-shaped land 40 are ensured, and further, uneven wear is suppressed.

As illustrated in FIG. 4, in plan view of the tire, when the length in the tire circumferential direction between the groove apex 33 of the V-shaped groove 30 and an end 31a of the first groove 31 closer to the opposite side to the forward side of the tire rotation direction is defined as X, and the length in the tire axial direction between an outer end 31b in the tire axial direction of the first groove 31 and an outer end 32b in the tire axial direction of the second groove is defined as Y, the ratio Y/X, i.e., the ratio of Y to X, is 20% or more and 70% or less.

FIG. 4 shows a first line 91 connecting the land apex 41 of the first V-shaped land 40 and the end 31a of the first groove 31 closer to the opposite side to the forward side of the tire rotation direction, and a second line 92 connecting the land apex 41 of the first V-shaped land 40 and the end 32a of the second groove 32 closer to the opposite side to the forward side of the tire rotation direction. An angle α formed between the first line 91 and the second line 92 is preferably 90° or less, and more preferably 50° or less.

Features of the tire 1 according to the present embodiment have been described above. The tire 1 exerts the following effects.
(1) The tire 1 according to the embodiment is a pneumatic tire including the tread 2 and having a tire rotation direction specified therefor. The tread 2 includes: the first V-shaped land 40 that is a V-shaped land projecting toward a forward side of the tire rotation direction; and the V-shaped groove 30 that is a groove externally defining the first V-shaped land 40. The first V-shaped land 40 includes the tapered portion 42 extending toward the forward side of the tire rotation direction from the leading edge 44 of the first V-shaped land 40 closer to the forward side of the tire rotation direction, and the tapered portion 42 is inclined from the leading edge 44 toward the bottom 34 of the V-shaped groove 30.

This feature increases the block rigidity of the tip portion of the first V-shaped land 40 to reduce the likelihood that kinking and uneven wear in the tip portion of the first V-shaped land 40, thereby making it possible to improve the steering stability.
(2) In the tire 1 according to the embodiment described in (1) above, it is preferable that, in a tire radial cross section, an angle θ formed between a virtual extension line VL extending toward the forward side of the tire rotation direction from the surface 40a of the first V-shaped land 40 and the surface 42a of the tapered portion 42 is 20° or more and 45° or less.

Due to this feature, the above-described increase in the block rigidity allows for sufficient improvement in the steering stability.
(3) In the tire 1 according to the embodiment described in (1) and (2) above, in a tire radial direction cross section, the curved concavity 43 having a concave cross section and continuing to the bottom 34 of the V-shaped groove 30 is formed from a leading end 42b of the tapered portion 42 closer to the forward side of the tire rotation direction toward the forward side of the tire rotation direction.

Due to this feature, the volume of the V-shaped portion 39 of the V-shaped groove 30, which externally defines the first V-shaped land 40, is ensured, so that drainage performance is improved, stress is easily dispersed through the curved concavity 43, and the block rigidity of the first V-shaped land 40 increases.
(4) In the tire 1 according to the embodiment described in (3) above, it is preferable that, in a tire radial cross section, the curved concavity 43 preferably has an arc-shaped cross section having a radius R of 1.0 mm or more and 5.0 mm or less.

This feature makes it possible to sufficiently improve the drainage performance and the block rigidity described above.
(5) In the tire 1 according to the embodiment described in (3) and (4) above, in a case where the height of the curved concavity 43 from the bottom 34 of the V-shaped groove 30 is defined as c, the height of the first V-shaped land 40 from the bottom 34 of the V-shaped groove 30 is defined as b, and the length of the tapered portion 42 in the tire circumferential direction is defined as a in the tire radial cross section, an angle θ formed between a virtual extension line VL extending toward the forward side of the tire rotation direction from the surface 40a of the first V-shaped land 40 and the surface 42a of the tapered portion 42 is expressed by the following equation:

$$θ = {tan}^{- 1} ( b - c ) / a .$$

(6) In the tire 1 according to the embodiment described in (3) and (4) above, in a case where the height of the curved concavity 43 from the bottom 34 of the V-shaped groove 30 is defined as c and the height of the first V-shaped land 40 from the bottom 34 of the V-shaped groove 30 is b in the tire radial cross section, the ratio c/b of c to b is preferably 5% or more and 50% or less.

Due to this feature, the block rigidity of the tip portion of the first V-shaped land 40 is easily improved.

As a result, the likelihood of kinking and uneven wear in the tip portion of the first V-shaped land 40 is reduced, thereby making it possible to improve the steering stability.
(7) In the tire 1 according to the embodiment described in (1) to (6) above, the V-shaped groove 30 has the groove apex 33 projecting toward the forward side of the tire rotation direction and includes the first groove 31 on one side of the groove apex 33 in the tire axial direction and the second groove 32 on the other side of the groove apex 33 in the tire axial direction. In a case where in a tire plan view, the length in the tire circumferential direction between the groove apex 33 of the V-shaped groove 30 and the end 31a of the first groove 31 closer to the opposite side to the forward side of the tire rotation direction is defined as X, and the length in the tire axial direction between the outer end 31b of the first groove 31 in the tire axial direction and the outer end 32b of the second groove 32 in tire axial direction is defined as Y, the ratio Y/X of Y to X is 20% or more and 70% or less. An angle α formed between the first line 91 and the second line 92 is 90° or less, the first line 91 connecting the land apex 41 of the first V-shaped land 40 projecting toward the forward side of the tire rotational direction and the end 31a of the first groove 31 closer to the opposite side to the forward side of the tire rotation direction, the second line 92 connecting the land apex 41 of the first V-shaped land 40 and the end 32a of the second groove 32 closer to the opposite side to the forward side of the tire rotation direction

The tread 2 having this configuration makes it possible to improve the steering stability and wear resistance, while ensuring drainage performance.

In the foregoing, a specific embodiment of the present invention has been described. It should be noted that the present invention is not limited to the above-described embodiment, and modifications, improvements, and the like within a range in which the object of the present invention can be achieved are also encompassed in the scope of the present invention.

### EXPLANATION OF REFERENCE NUMERALS

1: Tire (pneumatic tire)
2: Tread
30: V-shaped groove (groove)
31: First groove
32: Second grove
33: Groove apex of V-shaped groove
34: Bottom of groove
40: First V-shaped land (V-shaped land)
40a: Surface of first V-shaped land
41: Land apex of first V-shaped land
42: Tapered portion
42a: Surface of tapered portion
43: Curved concavity
44: Leading edge of first V-shaped land closer to forward side of tire rotation direction
91: First line
92: Second line
G1: Tire rotation direction
VL: Virtual extension line

What is claimed is:

1. A pneumatic tire comprising a tread and having a tire rotation direction specified therefor,
the tread including: a V-shaped land projecting toward a forward side of the tire rotation direction; and a groove externally defining the V-shaped land,
the V-shaped land including a tapered portion extending toward the forward side of the tire rotation direction from a leading edge of the V-shaped land closer to the forward side of the tire rotation direction, and the tapered portion being inclined from the leading edge toward a bottom of the groove.

2. The pneumatic tire according to claim 1, wherein, in a tire radial cross section, an angle θ formed between a virtual extension line extending toward the forward side of the tire rotation direction from a surface of the V-shaped land and a surface of the tapered portion is 20° or more and 45° or less.

3. The pneumatic tire according to claim 1, wherein, in a tire radial cross section, a curved concavity having a concave cross section and continuing to the bottom of the groove is formed from a leading edge of the tapered portion closer to the forward side of the tire rotation direction toward the forward side of the tire rotation direction.

4. The pneumatic tire according to claim 3, wherein, in the tire radial cross section, the curved concavity has an arc-shaped cross section having a radius R of 1.0 mm or more and 5.0 mm or less.

5. The pneumatic tire according to claim 3, wherein, when a height of the curved concavity from the bottom of the groove is defined as c, a height of the V-shaped land from the bottom of the groove is defined as b, and a length of the tapered portion in a tire circumferential direction is defined as a in the tire radial cross section, an angle θ formed between a virtual extension line extending toward the forward side of the tire rotational direction from a surface of the V-shaped land and a surface of the tapered portion is expressed by the following equation:
$$θ = {tan}^{- 1} ( b - c ) / a .$$

6. The pneumatic tire according to claim 3, wherein, when a height of the curved concavity from the bottom of the groove is defined as c and a height of the V-shaped land from the bottom of the groove is defined as b in the tire radial cross section, a ratio c/b of c to b is 5% or more and 50% or less.

7. The pneumatic tire according to claim 2, wherein, in a tire radial cross section, a curved concavity having a concave cross section and continuing to the bottom of the groove is formed from a leading edge of the tapered portion closer to the forward side of the tire rotation direction toward the forward side of the tire rotation direction.

8. The pneumatic tire according to claim 7, wherein, in the tire radial cross section, the curved concavity has an arc-shaped cross section having a radius R of 1.0 mm or more and 5.0 mm or less.

9. The pneumatic tire according to claim 7, wherein, when a height of the curved concavity from the bottom of the groove is defined as c, a height of the V-shaped land from the bottom of the groove is defined as b, and a length of the tapered portion in a tire circumferential direction is defined as a in the tire radial cross section, an angle θ formed between a virtual extension line extending toward the forward side of the tire rotational direction from a surface of the V-shaped land and a surface of the tapered portion is expressed by the following equation:
$$θ = {tan}^{- 1} ( b - c ) / a .$$

10. The pneumatic tire according to claim 7, wherein, when a height of the curved concavity from the bottom of the groove is defined as c and a height of the V-shaped land from the bottom of the groove is defined as b in the tire radial cross section, a ratio c/b of c to b is 5% or more and 50% or less.

11. The pneumatic tire according to claim 1, wherein
the groove is a V-shaped groove projecting toward the forward side of the tire rotation direction,
the V-shaped groove has a groove apex projecting toward the forward side of the tire rotation direction, and includes a first groove on one side of the groove apex in a tire axial direction and a second groove on the other side of the groove apex in the tire axial direction,
when, in a tire plan view, a length in a tire circumferential direction between the groove apex of the V-shaped groove and an end of the first groove closer to an opposite side to the forward side of the tire rotation direction is defined as X, and a length in a tire axial direction between an outer end of the first groove in the tire axial direction and an outer end of the second groove in tire axial direction is defined as Y,
a ratio Y/X of Y to X is 20% or more and 70% or less, and
an angle α formed between a first line and a second line is 90° or less, the first line connecting a land apex of the V-shaped land projecting toward the forward side of the tire rotational direction and the end of the first groove closer to the opposite side to the forward side of the tire rotation direction, the second line connecting the land apex of the V-shaped land and an end of the second groove closer to the opposite side to the forward side of the tire rotation direction.

12. The pneumatic tire according to claim 1, wherein
the groove is a V-shaped groove projecting toward the forward side of the tire rotation direction,
the V-shaped groove has a groove apex projecting toward the forward side of the tire rotation direction, and includes a first groove on one side of the groove apex in a tire axial direction and a second groove on the other side of the groove apex in the tire axial direction,
when, in a tire plan view, a length in a tire circumferential direction between the groove apex of the V-shaped groove and an end of the first groove closer to an opposite side to the forward side of the tire rotation direction is defined as X, and a length in a tire axial direction between an outer end of the first groove in the tire axial direction and an outer end of the second groove in tire axial direction is defined as Y,
a ratio Y/X of Y to X is 20% or more and 70% or less, and
an angle α formed between a first line and a second line is 90° or less, the first line connecting a land apex of the V-shaped land projecting toward the forward side of the tire rotational direction and the end of the first groove closer to the opposite side to the forward side of the tire rotation direction, the second line connecting the land apex of the V-shaped land and an end of the second groove closer to the opposite side to the forward side of the tire rotation direction.
